(19) United States
(12) Patent Application Publication
(10) Pub. No.: US 2024/0004968 A1
(43) Pub. Date: Jan. 4, 2024

(54) Audio and/or Physical Electronic Privacy System

(71) Applicant: Bank of America Corporation, Charlotte, NC (US)

(72) Inventors: Tomas M. Castrejon, III, Fort Mill, SC (US); Benjamin F. Tweel, Romeoville, IL (US); James Siekman, Morgantown, NC (US)

(21) Appl. No.: 17/854,530

(22) Filed: Jun. 30, 2022

(51) Int. Cl. G06F 21/14; G06F 3/16; H04N 21/234

(52) U.S. Cl. CPC G06F 21/14; G06F 3/165; H04N 21/23424

(57) ABSTRACT

In a public setting, an audio/visual (A/V) obfuscation device can be used to provide privacy during a conversation occurring either in-person or via an electronic device. The A/V obfuscation device is configured to provide one or both of an electronic or physical barrier to ensure privacy for at least part of the conversation. The A/V obfuscation device provides audio masking and/or an optical block to impede third-parties from overhearing or observing the conversation. The A/V obfuscation device includes devices capable of capturing audio and/or video information of conversation participants and/or electronic devices. The captured audio and/or video information may be analyzed and processed to generate obfuscation audio and/or video signals to obscure at least a portion of aspects of the conversation. The A/V obfuscation device can physically attach to an electronic device, can physically attach to a portion of a conversation participant, or may be a stand-alone device

### BACKGROUND

Today, people are in constant communication with others via their electronic devices. In public settings, communication device users may be near others, both known and unknown, who may be able to see and/or hear their conversations or interactions the user is having on their mobile or electronic device. For example, a user may communicate with others via their electronic device within an office building, a store, a restaurant, a conference room, a shopping mall, an airport, a library or a lobby, and/or the like. This communication may include private or other information that the user may not wish to be shared with unauthorized individuals. However, because of the public nature of the environment, the device user's conversation may be heard and/or seen by others nearby. For instance, a person may be speaking via their electronic device in an airport terminal, where other individuals may be positioned nearby and may hear a portion of the conversation spoken by the user and/or by the individual connected via the electronic device. Even if the conversation cannot be overheard, at least a portion of the conversation may be intercepted by another party by viewing the user's lips as they speak into their electronic device. Often, users may participate in video calls and/or meetings while in public places, where a video screen on the electronic device may display another individual speaking and/or display slides or other images as part of the conversation. This information may also be inadvertently shared with others positioned nearby.

This unintended audio and/or visual sharing of private and/or non-public information may result in disclosure of sensitive personal information and/or sensitive information such as medical information, financial information, legal information, and/or the like. For example, business communications may include exchanged information critical to an enterprise organization's operation. As such, securing such communications may be essential to protect the privacy of users communicating via electronic devices so that the information exchanged is not intelligible to unintended audience.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In a public setting, an audio/visual (AN) obfuscation device can be used to provide privacy during a conversation occurring either in-person or via an electronic device. The A/V obfuscation device is configured to provide one or both of an electronic or physical barrier to ensure privacy for at least part of the conversation. The A/V obfuscation device provides audio masking and/or an optical block to impede third-parties from overhearing or observing the conversation. The A/V obfuscation device includes devices capable of capturing audio and/or video information of conversation participants and/or electronic devices. The captured audio and/or video information may be analyzed and processed to generate obfuscation audio and/or video signals to obscure at least a portion of aspects of the conversation. The A/V obfuscation device can physically attach to an electronic device, can physically attach to a portion of a conversation participant, or may be a stand-alone device or unit.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an illustrative audio/visual (A/V) obfuscation device in accordance with one or more aspects described herein;

FIGS. 2A and 2B shows an illustrative system incorporating an A/V obfuscation device in accordance with one or more aspects described herein;

FIGS. 3A-C show illustrative systems incorporating an A/V obfuscation device with respect to a portable computing device in accordance with one or more aspects described herein;

FIGS. 4A-C show use of an illustrative wearable A/V obfuscation device in accordance with one or more aspects described herein;

FIG. 5 shows an illustrative process flow for performing A/V obfuscation in accordance with one or more aspects described herein; and

FIG. 6 shows an illustrative operating environment in which various aspects of the present disclosure may be implemented in accordance with this disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (i.e., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some example arrangements in which the systems described herein may be used. Various other arrangements employing aspects described herein may be used without departing from the innovative concepts described.

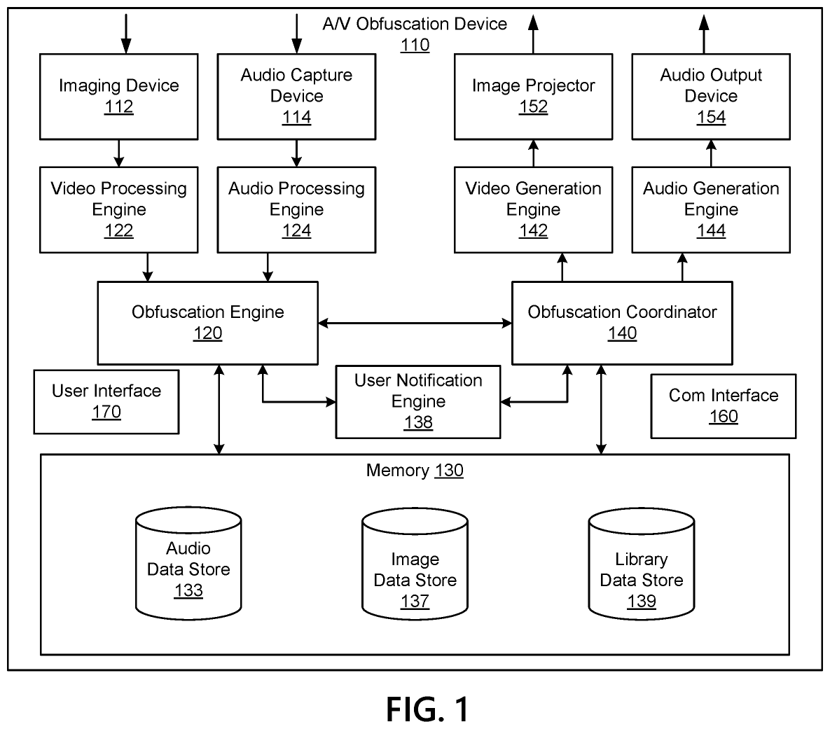

FIG. 1 shows an illustrative audio/visual (A/V) obfuscation device 110 in accordance with one or more aspects described herein. The A/V obfuscation device 110, based on its use and/or configuration, may include an imaging device 112, an audio capture device 114, an image projector 152, and an audio output device 154. The A/V obfuscation device 110 may be a computing device comprising at least one processor and memory devices. The processor of the A/V obfuscation device may process the instructions to perform certain programmed functions and/or to perform certain functionality to capture audio and/or video signals, process the captured audio and/or video signals, generate an obfuscation signal or signals, and the like. For example, the instructions may allow the A/V obfuscation device 110 to operate a video processing engine 122, an audio processing engine 124, an obfuscation engine 120, a user notification engine 138, an obfuscation coordinator 140, a video generation engine 142, an audio generation engine 144, and the like. Additionally, a memory 130 may store one or more data stores, such as an audio data store, an image data store 137, and a library data store 139. The A/V obfuscation device 110 may include a communication interface 160 configured to communicate, via one or more network connections, to an external computing device located either locally or remote. A user interface 170 may be provided to communicate messages to the user of the A/V obfuscation device 110.

The A/V obfuscation device 110 may be used in a public setting (e.g., a banking center, a pharmacy line, a sporting event, an airport terminal, a public vehicle, and the like) to provide privacy and security of information discussed during a conversation held while in that public setting. For example, the A/V obfuscation device 110 may be attached onto a communication device (e.g., a mobile phone, a laptop computer, a portable computing device, and the like) to provide privacy via a generated audio barrier and/or video barrier, with our without an accompanying physical barrier. The audio barrier, video barrier, and/or physical barrier may be used to provide audio masking and/or visual masking of a private conversation. Additionally, the A/V obfuscation device 110 may include an optical block to facilitate blocking third parties from visually seeing anything displayed on a screen of the communication device. In some cases, a physical and/or generated video-based visual barrier may be provided to obscure at least a portion of a user's face during the conversation.

As mentioned, the A/V obfuscation device 110 may capture audio and/or video signals corresponding to the environment in which it is being used to facilitate data privacy operations. For example, the imaging device 112 (e.g., a video camera, a light detection and ranging (lidar) device, an infrared camera, and/or the like) may capture one or more video signals (e.g., video streams) of the environment around the conversation to be held private. For example, the imagine device 112 may capture a video signal of an individual speaking (e.g., a person local to the A/V obfuscation device 110) and/or of an electronic device being used during the conversation. In some cases, in addition to or in place of the video signal, a lidar signal (e.g., lidar stream) may be captured to provide a three dimensional point cloud of the individual's face and/or of the electronic device. This lidar signal may be used for three dimensional modeling of the individual speaking, such as to facilitate generation of one or more visual masking or obfuscation signals. Additionally, a lidar signal of an electronic device may be used to capture an orientation of the device, such that a visual obfuscation or masking signal may be optimized for the particular angle in which the electronic device is orientated during use, with respect to the user and/or the A/V obfuscation device so that the obfuscation signal may be capable of obscuring a view of third parties within the vicinity of the conversation, while allowing a user to view information on a screen of the electronic device and/or allow a video camera of the electronic device to capture an unobscured (or minimally obscured) image of the user.

Similarly, the audio capture device 114 (e.g., a microphone, a connection for an external audio input, and the like) may capture one or more audio signals (e.g., audio streams) of the current conversation and/or of background sounds within the vicinity of the conversation. The audio signal may be processed to isolate a speaker's voice as they take part in the private conversation (e.g., the user local to the electronic device and/or a remote individual communicating remotely via the electronic device). While use of the imaging device 112 and the audio capture device 114 are discussed with respect to use during a conversation facilitated with use of an electronic device (e.g., a mobile phone conversation, a teleconference or video conference via a computing device and the like), the A/V obfuscation device 110 may also be used to provide privacy and/or information security when two or more participants in a conversation are local to the A/V obfuscation device 110. The imaging device 112 and the audio capture device may be used to capture real-time (or near real time) video and/or audio signals for at least a duration of the conversation. In some cases, the imaging device 112 and/or the audio capture device 114 may provide signals of a set duration (e.g., 1 second, 10 seconds, and the like) sampled at intervals (e.g., every 10 seconds, every 30 seconds, and the like) or intermittently sampled. In some cases, the audio processing engine 124 may process the captured audio signal to identify and reduce background noise captured by the microphone, such as to isolate an audio signal of interest (e.g., an audio signal to be obscured for privacy).

The video processing engine 122 and/or the audio processing engine 124 may process, respectively, the captured image signals from the imaging device 112 and the audio signals captured by the audio capture device 114. The video processing engine 122 may process the video signals to filter and/or color balance the signal and/or to isolate an object or person of interest within a field of view of the imaging device. For example, the video processing engine 122 may process the video signal to identify a location of certain facial features of a speaker (either local or on a video screen) and/or a location of a video screen within the field of view of the camera. Here, the video processing engine 122 may identify a location of a person's mouth while they are within the field of view of the camera and/or an orientation of their face with respect to the A/V obfuscation device 110 while they are speaking. Additionally, the video processing engine 122 may identify whether glare or other lighting effects are visible on a video screen or a person's facial features and filter these effects to provide an improved view of the features of interest.

Additionally, the video processing engine 122 and/or audio capture device 114 may process and combine signals from multiple sources. For example, the video processing engine 122 may combine a lidar signal with a video signal to generate an approximate real-color three dimensional image of the person and/or the electronic device. Also, the audio processing engine 124 may combine information received from an internal microphone and a signal received via an audio input to assemble a combined audio signal. For example, a user may participate in a video conference via an electronic device, where the received audio signal is heard by the user via an audio headset (e.g., headphones and the like). The A/V obfuscation device 110 may be electrically connected to an audio output of the electronic device, where the local audio signal of the user may be combined with the received audio signal to generate a more complete audio signal associated with the video conference. The video processing engine 122 and the audio processing engine 124 may also associate timing information with the processed video and audio signals, such that the video signal may be aligned with the audio signal for further processing.

The obfuscation engine 120 may process incoming video and/or audio signals to determine an obfuscation scheme to apply for a particular captured conversation. In some cases, the obfuscation engine 120 may analyze the processed video signal and/or audio signal to identify whether obfuscation is to be generated for one or more individuals local the A/V obfuscation device 110, a video screen of an electronic device or both of local user(s) and the video screen. In some cases, functionality of the obfuscation engine 120 and the obfuscation coordinator 140 may be combined in as a combined operation, or video obfuscation and audio obfuscation schemes may be determined separately by the obfuscation engine 120 and to be coordinated by the obfuscation coordinator 140.

The obfuscation engine 120 and/or the obfuscation coordinator 140 may access one or more data stores or databases in the memory 130, such as an audio data store 133, an image data store 137, and a library data store 139. The audio data store 133 may store audio clips and/or samples of users or other sounds for use in an audio obfuscation scheme. Similarly, the image data store 137 may store one or more user images, device images, object images or the like that may be used in a video obfuscation scheme. The library data store 139 may store preconfigured obfuscation schemes, such as to provide an audio and/or video obfuscation scheme that may be customized for use by the obfuscation engine and/or obfuscation coordinator. For example, the library data store may store audio or video samples of conversations about non-private subjects (e.g., the weather, restaurants, place descriptions, entertainment experiences, or the like) that may be used as a framework for an obfuscation scheme to be customized by the obfuscation engine 120 based on the processed audio and/or video signals.

In some cases, the obfuscation engine 120 may be configured to obscure a complete conversation, once activated by a user. At other times, the obfuscation engine may be configured to identify certain subjects or keywords within a captured audio or video signal before initiating the obfuscation scheme. For example, the obfuscation engine 120 may analyze the processed audio signal and not initiate obfuscation of a portion of a discussion where private information is typically not discussed, such as during a greeting or other social aspects of a conversation. When the obfuscation engine 120 identifies certain keywords or combination of key words in a discussion (e.g., “invest”, “buy”, certain numerical strings associated with personal or account identification, and the like), or transitional words and phrases that may be identified to precede such conversations, the obfuscation engine 120 may begin a pre-staged obfuscation scheme to obscure portions of the audio and/or video aspects of the conversation. Similarly, the obfuscation engine 120 may identify certain objects or keywords within a field of view of a video camera (e.g., a slide shown on a video screen, a local document, a credit card, and the like) where the obfuscation engine 120 may initiate obfuscation of at least a portion of the field of view while the particular object or text remains visible. For example, when a slide containing non-public information (e.g., an organization's financial information, a user's personal identification information, or the like) is displayed on a video screen, the obfuscation engine 120 may identify such information in a field of view, in real time, and may initiate a video obfuscation scheme to obscure at least the portion of the field of view containing the identified private information. Additionally, the obfuscation engine 120, and the obfuscation coordinator 140, may then also initiate an audio obfuscation scheme to anticipate a possible discussion of the private information and coordinate the audio and video obfuscation schemes as needed, in real time.

An audio obfuscation scheme may include one or more audio processing techniques to mask or otherwise obscure audio in the vicinity of the A/V obfuscation device 110. For example, the audio obfuscation scheme may include active noise cancelation of a captured audio signal or portions of the captured audio signal, generation of a white noise signal at a volume level that may mask a conversation outside a particular distance from the A/V obfuscation device 110. In some cases, the audio obfuscation scheme may include generation of an audio signal with a noise cancelation to limit a distance at which a current conversation may be heard, while inserting an obscuring audio signal that substitutes a different simulated real-time conversation. In some cases, the generated video obfuscation signal may be synchronized with the generated audio obfuscation signal. In some cases, the generated video obfuscation signal may be broadcast separate from the generated audio obfuscation signal. The obfuscation engine 120 and/or the obfuscation coordinator 140 may determine an obfuscation scheme using artificial intelligence and/or machine learning operations. For example, an artificial intelligence engine and/or machine learning engine may process a model for obscuring video and/or audio signals. The model may be trained on known data sets that include video and/or audio of individuals discussing private information, such as a simulated conversation concerning financial information, health information, and the like. The trained models may be uploaded to the A/V obfuscation device via the communication interface 160 and stored in one or more of the audio data store 133, the image data store 137, the library data store 139 and/or a model data store. The models may be processed using the processed image signals and/or audio signals to identify an obfuscation scheme identified by a combination of factors identified from the processed audio and/or video signals. The models may be used in a continuous learning environment based on feedback from past operation locally to the A/V obfuscation device 110 and/or from operation of other devices at remote locations. Feedback may be received via the user interface 170 and/or the communication interface 160.

Once the obfuscation scheme is identified and activated, the obfuscation engine 120 and/or the obfuscation coordinator 140 may initiate generation of associated obfuscation signals by the video generation engine 142 and/or the audio generation engine 144. The video generation engine 142 may generate a video obfuscation signal that my be projected by the image projector 152 and/or the audio output device 154 may output an audio obfuscation signal by the audio output device 154 (e.g., a speaker). In some cases, the video obfuscation signal may be generated to mask or otherwise obscure movement of an individual's mouth of a human local to the A/V obfuscation device 110 and/or on a screen of the electronic device used for video conferencing. In some cases, the appearance of a person's mouth may be obscured completely (e.g., with an image of a mask or other static image) or may be obscured with a video of a simulated mouth that may be moving differently than necessary to conduct the private conversation. For example, a person may be having a conversation about financial information, while a video may be projected to display over their mouth where the video mouth may be moving to a different conversation, such as about the weather. In some cases, an audio signal may be coordinated with the video signal, such as the obscuring audio signal may correspond to the simulated conversation (e.g., about the weather) as is occurs in the simulated video. Additionally, the simulated audio signal may be generated to generate an audio signal that sufficiently cancels the audio spoken by the human outside of a specified distance from the A/V obfuscation device 110. In some cases, the generated video obfuscation signals may be continuously generated throughout the conversation. In some cases, the generated obfuscation video and/or generated obfuscation audio may be intelligently generated, such as based on a model trained to identify sensitive words and/or topics, so that only sensitive portions of the conversation are masked.

The user notification engine 138 may be communicatively coupled to the obfuscation engine 120, the obfuscation coordinator 140, the communication interface 160 and/or the user interface 170. The user notification engine 138 may generate notification to the user to identify whether the A/V obfuscation device is operating normally (e.g., via a light emitting diode), actively monitoring input received via the imaging device 112 and/or the audio capture device 114, or generating obfuscation video via the image projector 152 and/or obfuscation audio via the audio output device 154. In some case, the user notification engine 138 may notify a user that configuration is necessary and may solicit configuration information via the communication interface. For example, a user interface screen may be displayed via a web browser or an application user interface screen to configure operation of the A/V obfuscation device 110. Additionally, errors and/or a need to update model training data may also be communicated via the user interface 170.

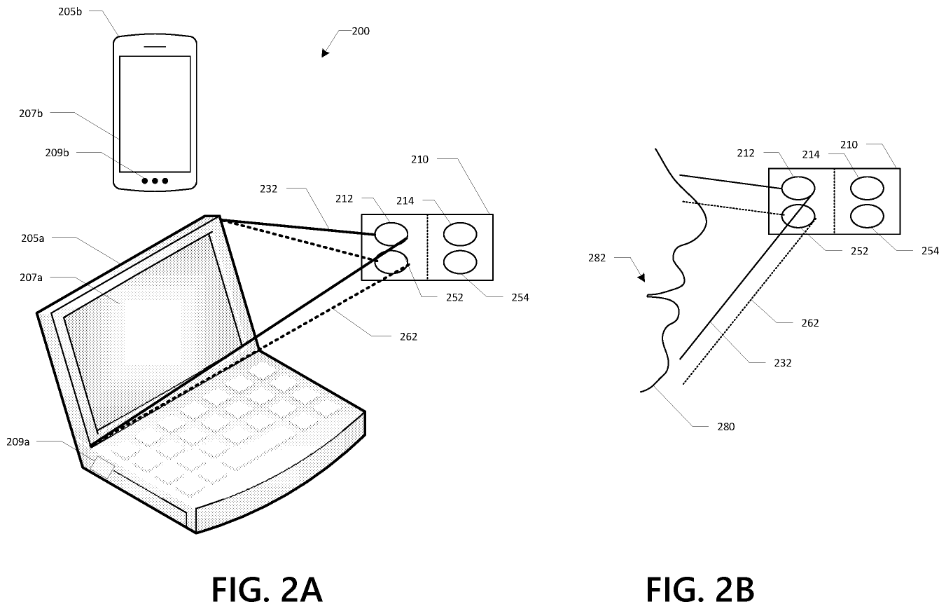

FIGS. 2A and 2B shows an illustrative system incorporating an A/V obfuscation device 110 in accordance with one or more aspects described herein. System 200 illustrate an A/V obfuscation device 210 including an imaging device (e.g., a video camera 212) having a field of view 323 observing a computing device 205a (e.g., a laptop computer). While the A/V obfuscation device is shown in relation to the computing device 205a, a different computing device may be monitored, such as a smart phone 205b having a video screen 207b and a speaker 209b. A image projector 252 may have a field of view 262 that coordinates with the field of view 232 of the video camera 212. In some cases, the fields of view may be different. The computing device 205a may include a video display 207a and an audio output 209a, where the field of view 232 of the video camera 212 may include a view of the computing device 205a or a portion of the computing device 205a, such as the video screen 207a, a portion of the video screen 207a, a portion of a keyboard, and the like.

The A/V obfuscation device 210 may also include an audio input device 214 (e.g., a microphone, an audio input connector, and the like) and an audio output device 254 (e.g., a speaker), such that the audio input device 214 may receive audio input from an environment near the A/V obfuscation device 210, such as from the speaker 209a of the computing device 205a. The A/V obfuscation device may then output obfuscation audio via the audio output device 254 to obscure, at least a portion of the audio output from the computing device's speaker 209a. In some cases, the A/V obfuscation device may be positioned separately from the electronic device, as shown. In some cases, the A/V obfuscation device 210 may include a physical feature (e.g., a case, a shield, or the like) to provide a visual or audio barrier to physically obscure at least a portion of the audio and/or video output from the computing device 205a. For example, the A/V obfuscation device 210 may be positioned adjacent to the computing device 205a, such that a portion of the video screen 207a and/or the keyboard is obscured from view for individuals at a certain position relative to the computing device 205a. For other individuals, the audio and/or video output of the computing device may be obscured with obfuscation video and/or obfuscation audio output from the A/V obfuscation device.

Similarly, FIG. 2B shows the A/V obfuscation device 210 positioned relative to a human, such that the field of view 232 of the camera 212 includes at least a portion of a person's face 280, such as the person's mouth 282. In some cases, the obfuscation video output 262 from the projector 252 that may at least partially obscure movement of the person's mouth 282. In some cases, a same A/V obfuscation device 210 may be configured to monitor both a person and a computing device, where one or more video and/or audio obfuscation outputs may be generated to obscure portions of the individual or the computing device.

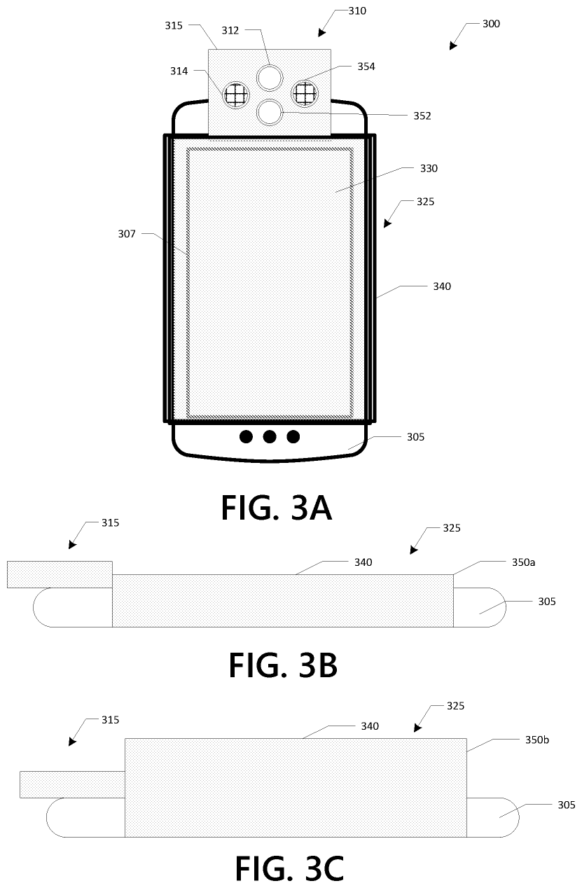

FIGS. 3A-C show illustrative systems incorporating an A/V obfuscation system 300 including an A/V obfuscation device 310 used with a portable computing device (e.g., a smart phone 305) with respect to a portable computing device in accordance with one or more aspects described herein. In FIG. 3A, the smart phone 305 may include a video screen 307 and a speaker 309. The A/V obfuscation device 210 may include a computing portion 315 and a static portion 325. The computing portion 315 may correspond to the computer system discussed with respect to FIG. 1 and may include a video camera 312, a microphone 314, a projector 352, and a speaker 354. In some cases, the computing portion 315 may comprise a complete A/V obfuscation device 310 that may physically connect to the portable computing device or a case of the portable computing device. In some cases, the static portion 325 may be separate from the computing portion 315 such that the computing portion 315 is physically removable from the static portion 325. In some cases, the computing portion 315 is integrated with the static portion 325. The static portion may include a frame 350 that may form a physical connection with the smart phone 305, such that the A/V obfuscation device 310 is physically attached to the smart phone 305 via the frame 340. For example, the frame 340 may clip on to the smart phone 305 and/or may include one or more clips that physically connect the frame 340 to the smart phone 305 or to a case around the smart phone. In some case, the static portion of the frame 340 may include a screen 330 that may at least partially obscure a view of the display 307 from individuals outside a certain viewing angle. In some cases, the screen 330 may include a partially transparent display upon which the computing portion 315 may generate an obfuscation video that may at least partially obscure a portion of the display 307 from individuals outside a specified viewing angle. For example, a user may view the display 307 from an angle (e.g., within 30 degrees of vertical) at which the display is unobscured, but an individual at a different viewing angle (outside 40 degrees from vertical) may view a different obfuscation video output by the A/V obfuscation device 310.

FIGS. 3B and 3C show illustrative side views of the A/V obfuscation device 310 with the computing portion 315 and the static portion 325. Here, the sides of the frame 340 may include a sidewall 350a, 350b. The sidewall 350a, 350b may extend from near a bottom of the smart phone 305 and may include a clip or slot to physically connect the smart phone 305 to the A/V obfuscation device 325. In some cases, the sidewall 350a may extend a short distance above the top surface (e.g., the display 307) of the smart phone and may provide minimal physical screening capability from individuals in the vicinity of the device's user. In some cases, the sidewall 350b may extend a greater distance above the top surface of the smart phone 305 to provide additional physical screening capability to limit viewing of the display 307 to a smaller viewing angle. In some cases, the sidewall may be capable of extending between a short position (e.g., sidewall 350a) to a tall position (e.g. sidewall 350b) and/or anywhere in between.

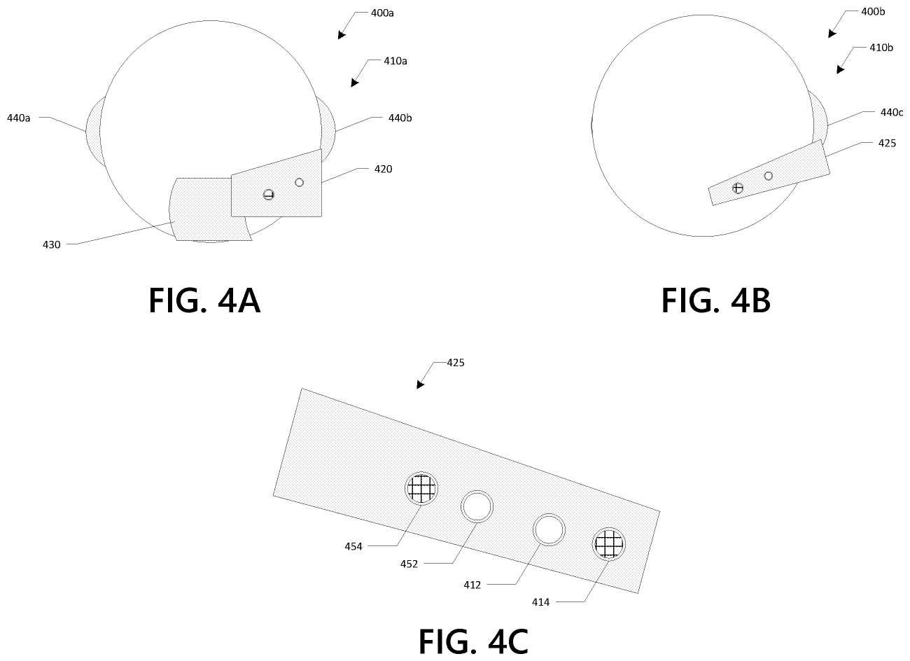

FIGS. 4A-C show use of an illustrative wearable A/V obfuscation device systems in accordance with one or more aspects described herein. FIGS. 4A and 4B show different configurations 400a, 400b of the A/V obfuscation device 110 configured as a wearable device for a human. In FIG. 4A, the A/V obfuscation device 410a may include one or more headphones 440a, 440b that may be connected, via a headband or other device configured to affix the A/V obfuscation device 410a to a person's head. The configuration 400a may include one or more physical arms that extend from one or both of the headphones 440a, 440b and partially obscure a person's mouth from view and/or may at least partially dampen audio when the person speaks. In some cases, the first portion 420 may include at least a majority of the electronic components, while the second portion 430 may be a static screen. Additionally, each of the first portion 420 and the second portion 430 may be movable to adjust to a person's anatomy to allow for different levels of screening to a person's mouth and/or spoken audio. In some cases, the second portion 430 may be removable.

FIG. 4B shows a different configuration 400b, where a headset may include a single headphone 440c and a computing section 425 that may partially screen a portion of the wearer's face. A reverse of the computing portion 425 is shown with a video camera 412, a microphone 414, a projector 452 and a speaker 454 is shown in FIG. 4C. In some cases, the wearable A/V obfuscation devices 410a and 410b may include a wired or wireless connection to an electronic device, where the electronic device's audio can be heard by the user via the headphone(s) 440a, 440b, and/or 440c. In some cases, the audio from the electronic device may therefore, not need to be obscured. However, due to a selected listening volume, the audio output may be heard near the person, such that the obfuscation audio may be generated to obscure the person's speaking audio and the communicated audio. In some cases, one or more of the video camera 412, the microphone 414, the projector 452, and the speaker 454 may be located on the inside (e.g., towards the wearer's face), on the outside (away from the wearer's face) or in a combination, such that both the audio and/or video of the person speaking and/or a display device may be obscured. For example, for telephone calls, the A/V obfuscation device 410b may recognize that the communication is via audio only, so that an obfuscation video is not needed to be generated to obscure the electronic device.

FIGS. 3A-C and 4A-C show examples of physical configurations of an A/V obfuscation device. The shown configurations are illustrative and non-limiting, such that other physical configurations arrangements, designs, and the like to perform similar functionality as described may be contemplated.

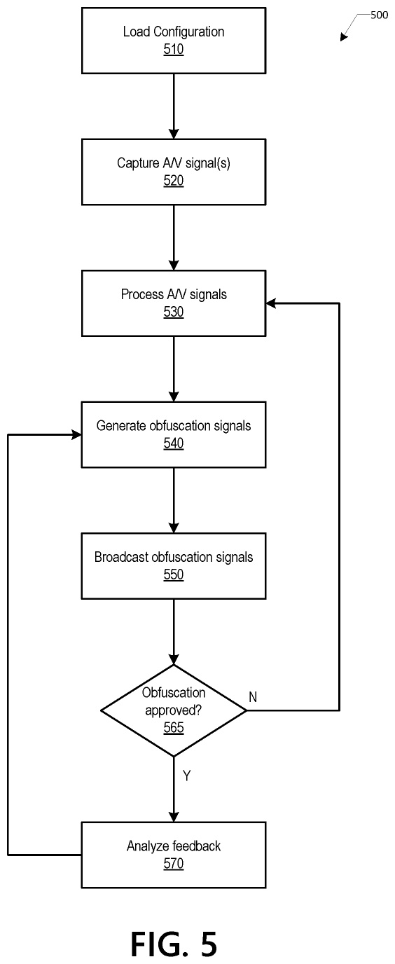

FIG. 5 shows an illustrative process flow 500 for performing A/V obfuscation in accordance with one or more aspects described herein. At 510, the A/V obfuscation device 110 may load a configuration file to identify a preferred obfuscation level, such as from a file stored in the memory 130. In some cases, the user interface 170 may include user interface devices (e.g., switches or buttons) to allow a user to manually enter a configuration, which then may be stored in a file in the memory 130. In some cases, a configuration file may be downloaded via the communication interface 160 via a website or application. The configuration may include a level of obfuscation desired, such as define a level for obscuring audio and/or video signals and/or whether to obscure audio only, video only, or a combination of audio and video. At 520, the A/V obfuscation device 110 may capture audio and/or video signals via the imaging device 112 and the audio capture device 114. At 530, the capture audio and video signals may be processed by the video processing engine 122 and the audio processing engine 124, such as to reduce noise and/or to extract signals for which obfuscation is desired or configured.

At 530, the obfuscation engine 120 and/or the obfuscation coordinator 140 may analyze the processed audio and video signals to determine an obfuscation scheme. In some cases, the obfuscation engine may process a trained AI/ML model that determines whether an audio signal and/or a video signal needs to be obfuscated. Additionally, the AI/ML model may determine how to obfuscate the video and/or audio signal based on a predicted future topic of conversation. Based on the model output, the obfuscation coordinator may determine timing of obfuscated video and/or audio signals to be generated. In some cases, the obfuscation engine 120 may extract images and/or audio clips corresponding to public topics of discussion, such as audio discussion of weather, entertainment, and the like. In some cases, the video images may correspond to the same or different public topics.

At 540, the obfuscation signals may be generated by the video generation engine 142 and/or the audio generation engine 144, based on the configuration and the topics or schemes identified by the obfuscation engine 120. The video generation engine 142 and/or the audio generation engine may incorporate images, audio clips, and or other information stored in memory. In some cases, obfuscation audio clips and/or obfuscation video clips generated by the video generation engine 142 and/or the audio generation engine 144 may be stored in the library data store 139 for use in the future, thus saving time and/or processing power of the obfuscation engine. At 550, the obfuscation audio signal and/or the obfuscation video signal may be broadcast by the A/V obfuscation device 110, such as by the image projector 152 and/or the audio output device 154. In some cases, the generated signals may be designed to obscure at least a portion of a user's face or a video screen, and/or a portion of audio spoken by the user and/or output by a computing device. At 565, the user may approve or disapprove the obfuscation based on their observations and may provide feedback, such as through the user interface 170 and/or the communication interface 160. If approved, the obfuscation engine 120, at 570, may identify the approved audio and/or video signal and store at least a portion of the approved signal in the library data store 139. Additionally, the approved or disapproved feedback may be used by the obfuscation engine to continually train the AI/ML models. If, at 565, the one or more of the obfuscation signals are not approved, then the obfuscation engine 120, at 530, may revise a strategy and initiate regeneration of the disapproved signal. Additionally, the disapproved information may be stored in the library data store 139 for use in continually training the AI/ML model.

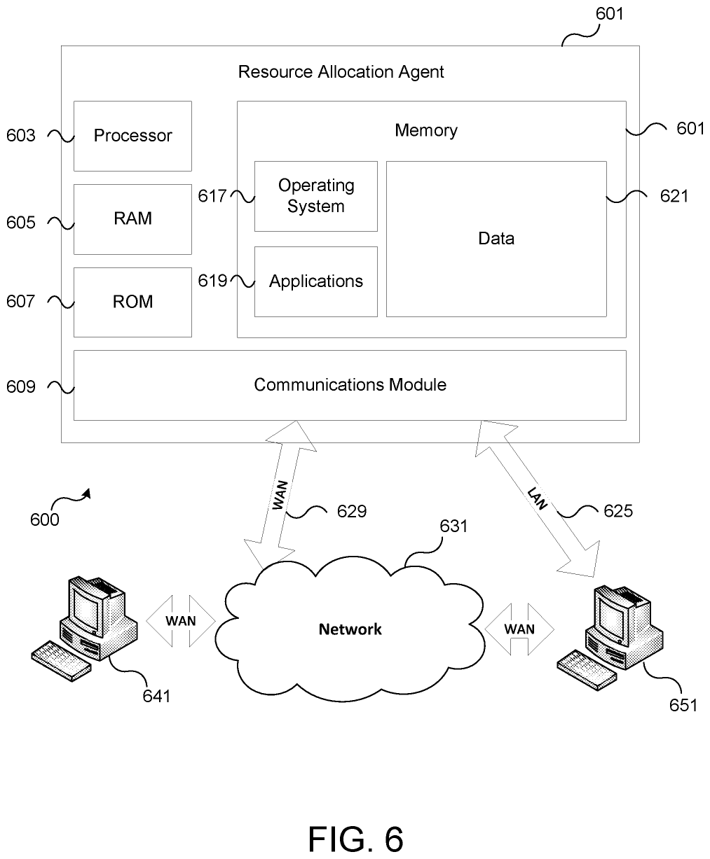

FIG. 6 shows an illustrative operating environment in which various aspects of the present disclosure may be implemented in accordance with this disclosure. Referring to FIG. 6, a computing system environment 600 may be used according to one or more illustrative embodiments. The computing system environment 600 is only one example of a suitable computing environment and is not intended to suggest any limitation as to the scope of use or functionality contained in the disclosure. The computing system environment 600 should not be interpreted as having any dependency or requirement relating to any one or combination of components shown in the illustrative computing system environment 600.

The computing system environment 600 may include an illustrative A/V obfuscation device 601 having a processor 603 for controlling overall operation of the A/V obfuscation device 601 and its associated components, including a Random-Access Memory (RAM) 605, a Read-Only Memory (ROM) 607, a communications module 609, and a memory 615. The A/V obfuscation device 601 may include a variety of computer readable media. Computer readable media may be any available media that may be accessed by the A/V obfuscation device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by the A/V obfuscation device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed by the processor 603 of the A/V obfuscation device 601. Such a processor may execute computer-executable instructions stored on a computer-readable medium.

Software may be stored within the memory 615 and/or other digital storage to provide instructions to the processor 603 for enabling A/V obfuscation device 601 to perform various functions as discussed herein. For example, the memory 615 may store software used by the A/V obfuscation device 601, such as an operating system 617, one or more application programs 619, and/or an associated database 621. In addition, some or all of the computer executable instructions for the A/V obfuscation device 601 may be embodied in hardware or firmware. Although not shown, the RAM 605 may include one or more applications representing the application data stored in the RAM 605 while the A/V obfuscation device 601 is on and corresponding software applications (e.g., software tasks) are running on the A/V obfuscation device 601.

The communications module 609 may include a microphone, a keypad, a touch screen, and/or a stylus through which a user of the A/V obfuscation device 601 may provide input, and may include one or more of a speaker for providing audio output and a video display device for providing textual, audiovisual and/or graphical output. The computing system environment 600 may also include optical scanners (not shown).

The A/V obfuscation device 601 may operate in a networked environment supporting connections to one or more remote computing devices, such as the computing devices 641 and 651. The computing devices 641 and 651 may be personal computing devices or servers that include any or all of the elements described above relative to the A/V obfuscation device 601.

The network connections depicted in FIG. 6 may include a Local Area Network (LAN) 625 and/or a Wide Area Network (WAN) 629, as well as other networks. When used in a LAN networking environment, the A/V obfuscation device 601 may be connected to the LAN 625 through a network interface or adapter in the communications module 609. When used in a WAN networking environment, the A/V obfuscation device 601 may include a modem in the communications module 609 or other means for establishing communications over the WAN 629, such as a network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server. Any of various web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

1. A system comprising:
a computing device comprising a video display and an audio output, wherein the computing device facilitates a communication between a user and a second individual at a remote location; and
an audio/visual (AN) obfuscation device comprising:
a processor; and
non-transitory memory storing instructions that, when executed by the processor, cause the A/V obfuscation device to:
capture, by an imaging device, a first video stream comprising an image of at least a portion of one or both of the communication device and a user of the communication device;
generate, by an obfuscation engine and based on the image, a second video stream obscuring at least one of the portion of one or both of the communication device and the user; and
project, by an image projection device, the second video stream onto at least one or both of the communication device and the user.

2. The system of claim 1, wherein the imaging device comprises a video camera;

3. The system of claim 1, wherein the imaging device comprises one or both of a video camera and a light detection and ranging (lidar) device, and wherein the instructions further cause the A/V obfuscation device to combine the first video stream with a lidar stream from the lidar device to form a combined video stream, and generate the second video stream based on the combined video stream.

4. The system of claim 1, wherein the second video stream provides an image to obscure a mouth of the user.

5. The system of claim 1, wherein the second video stream projects a static image onto one or both of a user's face and a video screen of the communication device.

6. The system of claim 1, wherein the second video stream projects a moving image onto one or both of a user's face and a video screen of the communication device.

7. The system of claim 1, wherein the A/V obfuscation device further comprises an audio capture device, and wherein the instructions further cause the A/V obfuscation device to:
capture, by the audio capture device, a first audio stream associated with the user and the communication between the user and the second individual at the remote location;
generate, in real-time and by the obfuscation engine and based on the first audio stream, an audio obfuscation stream to obscure at least a portion of the first audio stream; and
transmit, by an audio generation device, the audio obfuscation stream.

8. The system of claim 7, wherein the instructions further cause the A/V obfuscation device to synchronize the second video stream and the audio obfuscation stream.

9. The system of claim 8, wherein synchronization of the second video stream and the audio obfuscation stream comprises a synchronized audio and visual representation of a different conversation.

10. The system of claim 1, wherein the A/V obfuscation device further comprises a physical screen to obscure a portion of one or more of a user's face and the computing device.

11. The system of claim 1, wherein the A/V obfuscation device comprises a stand-alone unit.

12. The system of claim 1, wherein the A/V obfuscation device is configured to physically attach to the computing device.

13. The system of claim 1, wherein the A/V obfuscation device is configured to physically attach to the user.

14. The system of claim 1, wherein the computing device comprises one of a mobile computing device or a smart phone.

15. An apparatus comprising:
a processor; and
non-transitory memory storing instructions that, when executed by the processor, cause the apparatus to:
capture, by an imaging device, a first video stream comprising an image of at least a portion of one or both of a communication device and a user of the communication device;
generate, by an obfuscation engine and based on the image, a second video stream obscuring at least one of the portion of one or both of the communication device and the user; and
project, by an image projection device, the second video stream onto at least one or both of the communication device and the user.

16. The apparatus of claim 15, wherein the second video stream provides an image to obscure a mouth of the user.

17. The apparatus of claim 15, wherein the second video stream projects a static image onto one or both of a user's face and a video screen of the communication device.

18. The apparatus of claim 15, wherein the apparatus further comprises an audio capture device, and wherein the instructions further cause the apparatus to:
capture, by the audio capture device, a first audio stream associated with the user and the communication between the user and the second individual at a remote location;
generate, in real-time and by the obfuscation engine and based on the first audio stream, an audio obfuscation stream to obscure at least a portion of the first audio stream; and
transmit, by an audio generation device, the audio obfuscation stream.

19. The apparatus of claim 18, wherein the instructions further cause the apparatus to synchronize the second video stream and the audio obfuscation stream.

20. The apparatus of claim 18, wherein the apparatus comprises a headset wearable by user.
